(19) United States
(12) Patent Application Publication
(10) Pub. No.: US 2019/0155077 A1
(43) Pub. Date: May 23, 2019

(54) PROCESS OF PRODUCING A LIQUID CRYSTAL DISPLAY AND A THERMOSET RESIN COMPOSITION USED IN THE SAME

(71) Applicant: HENKEL AG & CO. KGAA, Duesseldorf (DE)

(72) Inventors: Baoshan Gao, Shanghai (CN); Tengfang Wang, Shanghai (CN); Minghai Wang, Shanghai (CN); Kangcheng Lou, Shanghai (CN); Dawei Chen, Shanghai (CN)

(21) Appl. No.: 16/242,038

(22) Filed: Jan. 8, 2019

Related U.S. Application Data
(63) Continuation of application No. PCT/CN2016/089411, filed on Jul. 8, 2016.

(51) Int. Cl. G02F 1/1339; G02F 1/1341

(52) U.S. Cl. CPC G02F 1/1339; G02F 2202/025; G02F 2001/13415; G02F 1/1341

(57) ABSTRACT

The present invention relates to an improved one-drop-filling process of producing a liquid crystal display having a liquid crystal layer between a first substrate and a second substrate, comprising steps of applying a thermally curable resin composition on a sealing region at a periphery of a surface of the first substrate; conducting a first thermal curing of the thermally curable resin composition at a temperature of 40° C. to 75° C., and obtaining a partially cured product; dropping liquid crystal on a central area encircled by the sealing region of the surface of the first substrate or the corresponding area of the second substrate, and forming the liquid crystal layer; overlaying the second substrate on the first substrate; and conducting a second thermal curing of the partially cured product.

### FIELD OF THE INVENTION

This invention relates to a process of producing a liquid crystal display and to a thermally curable resin composition used in the same. In particular, the invention relates to an improved one-drop-filling process of producing a liquid crystal display.

### BACKGROUND OF THE INVENTION

Liquid crystal display (LCD) panels having the characteristics of being light-weight and high-definition have been widely used as display panels for a variety of apparatuses including cell phones and TVs. Conventionally, the process for producing a LCD panel is called a one-drop-filling (ODF) process which, as shown in FIG. 1, comprising applying a sealant on a substrate having an electrode pattern and an alignment film under vacuum condition, dropping liquid crystal (LC) on the substrate having the sealant applied thereon, joining opposite facing substrates to each other under vacuum, then releasing the vacuum and performing ultraviolet (UV) radiation or UV radiation plus heating to cure the sealant and thereby producing a LCD cell.

Recently, development of LCD has been more towards the direction of “slim border” or “narrow bezel” design. Among several ways to achieve this goal, one is the use of a narrow width of the sealant. However, a thinner line of sealant creates more challenge with typical ODF process due to the fact that the process needs to meet very high reliability to prevent the liquid crystal material from leakage, misalignment and contamination.

In addition, in normal ODF process, radiation curing, such as UV curing, and thermal curing are used to cure the sealant by single use or combination. UV light can be irradiated from color filter side and array side of the cell. In recent years, picture frames of LCD part have been narrowed down for the downsizing of LCD containing equipment such as mobile phones, mobile game machines. Therefore, patterns of the sealant formed on a substrate is increasingly located at a position overlapping with the black matrix. This may cause a problem as the overlapping portion of sealant on black matrix remains uncured and flowable even after being UV irradiated. The uncured sealant easily elutes from the overlapping portion into liquid crystal which causes LC contamination.

On the other hand, although irradiating UV light from array side is also conceivable, challenges still remain since metal wirings and transistors on the array substrate overlap with the sealant pattern and create shadow area, which may in turn result in “shadow cure” issue as uncured portion of the sealant is apt to elute from sealant and comes into contact with LC which will also cause LC contamination.

Thus, there is still a need for an improved ODF process that can solve above-mentioned challenges. In particular, the present invention provides a modified ODF process in which the sealant is partially cured prior to the coupling of the substrates. As a result, the ODF process according to the present invention may take the advantage of elimination of shadow cure issue, better misalignment of liquid crystal, as well as much less leakage and contamination of liquid crystal, compared to a ODF process currently applied in the art.

### BRIEF DESCRIPTION OF THE FIGURES

FIG. 1 illustrates a flow chart of ODF process according to prior art.

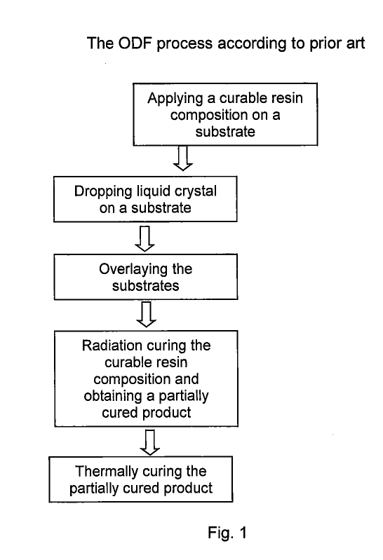

FIG. 2 illustrates a flow chart of ODF process according to present invention.

FIG. 3 illustrates a liquid crystal display component used in the sealing performance evaluation.

### SUMMARY OF THE INVENTION

The present invention provides a process of producing a liquid crystal display having a liquid crystal layer between a first substrate and a second substrate, said process comprising steps of:
1) applying a thermally curable resin composition on a sealing region at a periphery of a surface of the first substrate;
2) conducting a first thermal curing of the thermally curable resin composition at a temperature of 40° C. to 75° C., and obtaining a partially cured product;
3) dropping liquid crystal on a central area encircled by the sealing region of the surface of the first substrate or the corresponding area of the second substrate, and forming the liquid crystal layer;
4) overlaying the second substrate on the first substrate; and
5) conducting a second thermal curing of the partially cured product.

The present invention also provides a thermally curable resin composition used for the process of producing a liquid crystal display according to the present invention.

Furthermore, the present invention provides a liquid crystal display manufactured by the process of producing a liquid crystal display according to the present invention.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

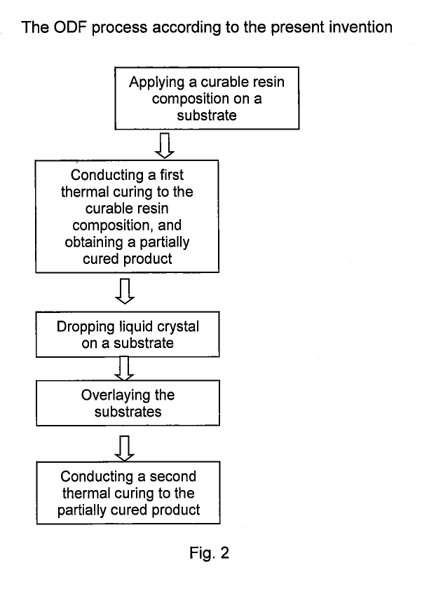

As shown in FIG. 2, the present invention concerns a process of producing a liquid crystal display having a liquid crystal layer between a first substrate and a second substrate, said process comprising steps of:
1) applying a thermally curable resin composition on a sealing region at a periphery of a surface of the first substrate;
2) conducting a first thermal curing of the thermally curable resin composition at a temperature of 40° C. to 75° C., and obtaining a partially cured product;
3) dropping liquid crystal on a central area encircled by the sealing region of the surface of the first substrate or the corresponding area of the second substrate, and forming the liquid crystal layer;
4) overlaying the second substrate on the first substrate; and
5) conducting a second thermal curing of the partially cured product.

In the present invention, it has been surprisingly found that the ODF process according to the present invention allows for an improved reliability and an excellent quality of the LCD display produced by the process.

Specifically, it is an advantage of the process of producing a LCD to provide a LCD cell assembly without liquid crystal penetration and leakage.

It is another advantage of the process of producing a LCD to improve the liquid crystal alignment of the LCD assembly.

It is yet another advantage of the process of producing a LCD to eliminate the shadow cure issue.

Step 1)

In step 1) of the LCD producing process according to the present invention, the thermally curable resin composition is applied on the periphery portion of the surface of the first substrate so as to lap around the substrate circumference in a frame shape. The portion where the thermally curable resin composition is applied in a frame shape is referred as a sealing region. The thermally curable resin composition can be applied by a known method in the art such as screen printing and dispensing, preferably by dispensing.

The sealing region generally has a rectangular box shape, LCD display portion is formed in the sealing region inside the central zone. The sealing region on the outer surface of the substrate, electrode and electrical/electronic parts installation space may be used if desired.

The first substrate used in the present invention are usually transparent glass substrates. Generally, transparent electrodes, active matrix elements (such as thin film transistor TFT), alignment film(s), a color filter and the like are formed on at least one of the opposed faces of the two substrates. These constitutions may be modified according to the type of LCD. The manufacturing method according to the present invention may be thought to be applied for any type of LCD.

Thermally Curable Resin Composition

The thermally curable resin composition or sealant composition suitable to be used in the present process comprises a thermally curable resin and a thermally curing agent.

Specifically, the thermally curable resin used in the present is selected from the group consisting of a (meth)acrylic resin, an epoxy resin, and combination thereof. As used herein, the term “(meth)acrylic resin” refers to an acrylic resin and methacrylic resin both.

Examples of the (meth)acrylic resin includes but not limited to a ester compound obtainable by a reaction of a (meth)acrylic acid with a compound having a hydroxyl group, epoxy (meth)acrylate obtainable by a reaction of a (meth)acrylic acid with an epoxy compound, and urethane (meth)acrylate obtainable by a reaction of an isocyanate with a (meth)acrylic acid derivative having a hydroxyl group, and mixture or combination thereof.

The ester compound obtainable by the reaction of a (meth)acrylic acid with a compound having a hydroxyl group is not particularly limited. Examples of the ester compound with a mono-functional group include but not limited to 2-hydroxyethyl (meth)acrylate, 2-hydroxybutyl (meth)acrylate, isobutyl (meth)acrylate, phenoxy polyethylene glycol (meth)acrylate, imide (meth)acrylate, methyl (meth)acrylate, ethyl (meth)acrylate, n-butyl (meth)acrylate, propyl (meth)acrylate, n-butyl (meth)acrylate, cyclohexyl (meth)acrylate, and 2-ethylhexyl (meth)acrylate. Examples of the ester compound with two functional groups include but not limited to 1,6-hexanediol di(meth)acrylate, and 1,9-nonanediol di(meth)acrylate. Examples of the ester compound with three or more functional groups include pentaerythritol tri(meth)acrylate, and trimethylolpropane tri(meth)acrylate.

The epoxy (meth)acrylate is a derivative of epoxide resin which has one or more (meth)acrylate groups and are substantially free of epoxy groups, obtainable by reaction of a (meth)acrylic acid with an epoxy compound. According to the present invention, the epoxy (meth)acrylate refers to a specific type of (meth)acrylate resin, rather than an epoxy resin. Examples include an epoxy (meth)acrylate obtainable by reaction of an epoxy resin with (meth)acrylic acid in the presence of a basic catalyst according to a known method in the art. Preferably, the epoxy (meth)acrylate is a fully acrylated compound in which almost 100% of the epoxy groups can be converted to acrylic groups.

Examples of the epoxy (meth)acrylate commercially available include but not limited to Ebecryl 3700, Ebecryl 3600, Ebecryl 3701, Ebecryl 3703, Ebecryl 3200, Ebecryl 3201, Ebecryl 3600, Ebecryl 3702, Ebecryl 3412, Ebecryl 860, Ebecryl RDX63182, Ebecryl 6040, Ebecryl 3800 (all manufactured by Daicel UCB Co., Ltd.), EA-1020, EA-1010, EA-5520, EA-5323, EA-CHD, EMA-1020 (all manufactured by Shin-Nakamura Chemical Co., Ltd.).

The urethane (meth)acrylate obtainable by reaction of the isocyanate with a (meth)acrylic acid derivative having a hydroxyl group can be obtained by reacting 1 equivalent amount of a compound having two isocyanate groups with 2 equivalent amount of the (meth)acrylic acid derivative having a hydroxyl group in the presence of a catalyst amount of tin compounds.

Examples of the commercially available urethane (meth)acrylate include M-1100, M-1200, M-1210, M-1600 (all manufactured by Toagosei Co., Ltd.), Ebecryl 230, Ebecryl 270, Ebecryl 4858, Ebecryl 8402, Ebecryl 8804, Ebecryl 8803, Ebecryl 8807, Ebecryl 9260, Ebecryl 1290, Ebecryl 5129, Ebecryl 4842, Ebecryl 210, Ebecryl 4827, Ebecryl 6700, Ebecryl 220, Ebecryl 2220 (all manufactured by Daicel UCB Co., Ltd.), Art Resin UN-9000H, Art Resin UN-9000A, Art Resin UN-7100, Art Resin UN-1255, Art Resin UN-330, Art Resin UN-3320HB, Art Resin UN-1200TPK, Art Resin SH-500B (all manufactured by Negami Chemical Industrial Co., Ltd.).

In one embodiment, the thermally curable resin is a (meth)acrylic resin, preferably an epoxy (meth)acrylic resin.

In another embodiment, the thermally curable resin is a urethane (meth)acrylate, preferably a hydroxy functional aliphatic urethane (meth)acrylate.

Epoxy Resin

The epoxy resin component of the present invention may include any common epoxy resin, including but not limited to, aromatic glycidyl ethers, aliphatic glycidyl ethers, aliphatic glycidyl esters, cycloaliphatic glycidyl ethers, cycloaliphatic glycidyl esters, cycloaliphatic epoxy resins, and mixtures thereof.

A suitable epoxy resin preferably ranges in number average molecular weight of 500 to 3000 g/mol. When the number-average molecular weight is within this range, the epoxy resin shows low solubility and diffusibility in the liquid crystal and permits the obtained liquid crystal display panel to exhibit excellent display characteristics. The number average molecular weight of the epoxy resin can be measured by gel permeation chromatography (GPC) using polystyrene standard.

Specific examples of the epoxy resin include aromatic polyvalent glycidylether compounds obtained by reaction, with epichlorohydrin, of aromatic diols such as bisphenol A, bisphenol S and bisphenol F, or modified diols obtained by modifying the above diols with ethylene glycol, propylene glycol and alkylene glycol; novolak-type polyvalent glycidylether compounds obtained by reaction, with epichlorohydrin, of novolak resins derived from phenols or cresols and formaldehydes, or polyphenols such as polyalkenylphenols and copolymers thereof; and glycidylether compounds of xylylene phenolic resins.

More preferably, cresol novolak epoxy resin, phenol novolak epoxy resin, bisphenol A epoxy resin, bisphenol F epoxy resin, triphenolmethane epoxy resin, tripheolethane epoxy resin, trisphenol epoxy resin, dicyclopentadiene epoxy resin and biphenyl epoxy resin may be used in the present invention.

Suitable commercially available epoxy resin to be used in the present invention are for example JER YL 980, a bisphenol A type epoxy resin, manufactured by Mitsubishi Chemical Corporation.

In one embodiment, the thermally curable resin is an epoxy resin, preferably a bisphenol A type epoxy resin.

The thermally curable resin is present from 30% to 95%, preferably from 50% to 90%, by weight of the thermally curable resin composition.

Thermally Curing Agent

The thermally curable resin composition further contains a thermally curing agent to ensure the thermal curing in steps 2) and 5) of the LCD production process according to the present invention. Usually a latent curing agent or a thermal free radical polymerization initiator can be used as the catalyst. A latent curing agent is preferably used in the thermally curable resin composition as thermally curing agent.

A latent curing agent is based on a latent hardener that will be liberated at a certain temperature. The latent curing agent can be obtained easily from the commercially available latent epoxy curing agent and used alone or in a combination of two or more kinds. Specifically, the latent epoxy curing agent to be preferably used includes amine-based compounds, fine-powder-type modified amine and modified imidazole based compounds. Examples of the amine-based latent curing agent include dicyandiamide, hydrazides such as adipic acid dihydrazide, oxalic acid dihydrazide, malonic acid dihydrazide, succinic acid dihydrazide, glutaric acid dihydrazide, suberic acid dihydrazide, azelaic acid dihydrazide, sebacic acid dihydrazide, and phthalic acid dihydrazide. The modified amine and modified imidazole based compounds include core-shell type in which the surface of an amine compound (or amine adducts) core is coated with the shell of a modified amine product (surface adduction and the like) and master-batch type hardeners as a blend of the core-shell type curing agent with an epoxy resin.

Examples of commercially available latent curing agents include, but not limited to: Adeka Hardener EH-5011S (imidazole type), Adeka Hardener EH-4357S (modified amine type), Adeka Hardener EH-4357PK (modified amine type), Adeka Hardener EH-4380S (special hybrid type), Adeka Hardener EH-5001P (special modified type), Ancamine 2014FG/2014AS (modified polyamine), Ancamine 2441 (modified polyam-ine), Ancamine 2337s (modified amine type), Fujicure FXR-1081 (modified amine type), Fujicure FXR-1020 (modified amine type), Sunmide LH-210 (modified imidaz-ole type), Sunmide LH-2102 (modified imidazole type), Sunmide LH-2100 (modified imidazole type), Ajicure PN-23 (modified imidazole type), Ajicure PN-23J (modified imidazole type), Ajicure PN-31 (modified imidazole type), Ajicure PN-31J (modified imidazole type), Novacure HX-3722 (master batch type), Novacure HX-3742 (master batch type), Novacure HX-3613 (masterbatch type), and mixture thereof.

In one preferred embodiment, latent curing agents having a melting temperature of 50 to 150° C., particularly having a melting temperature of 60 to 120° C. are suitable to be used in the thermally curable resin composition. Those having a melting temperature lower than 50° C. have the problem of poor viscosity stability, while those having a melting temperature higher than 150° C. need longer time of thermal curing, which causes a higher tendency of liquid crystal contamination.

Thermal free radical initiators are those can decompose and release free radicals when thermally activated, thereby initiate the crosslinking reaction of thermal resin in the thermal curing process of steps 2) and 5) to achieve a partial and full curing of the sealant composition.

Suitable thermal free radical initiators include, for example, organic peroxides and azo compounds that are known in the art. Examples include: azo free radical initiators such as AIBN (azodiisobutyronitrile), 2,2′-Azobis(4-methoxy-2,4-dimethyl valeronitrile), 2,2′-Azobis(2,4-dimethyl valeronitrile), Dimethyl 2,2′-azobis(2-ethylpropionate), 2,2′-Azobis(2-methylbutyronitrile), 1,11-Azobis(cyclohexane-1-carbonitrile), 2,2′-Azobis[N-(2-propenyl)-2-methylpropionamide]; dialkyl peroxide free radical initiators such as 1,1-di-(butylperoxy-3,3,5-trimethyl cyclohexane); alkyl per-ester free radical initiators such as TBPEH (t-butyl per-2-ethylhexanoate); diacyl peroxide free radical initiators such as benzoyl peroxide; peroxy dicarbonate radical initiators such as ethyl hexyl percarbonate; ketone peroxide initiators such as methyl ethyl ketone peroxide, bis(t-butyl peroxide) diisopropylbenzene, t-butylperbenzoate, t-butyl peroxy neodecanoate, and mixture thereof.

Further examples of organic peroxide free radical initiators include: dilauroyl peroxide, 2,2-di(4,4-di(tert-butylperoxy)cyclohexyl)propane, di(tert-butylperoxyisopropyl) benzene, di(4-tert-butylcyclohexyl) peroxydicarbonate, dicetyl peroxydicarbonate, dimyristyl peroxydicarbonate, 2,3-dimethyl-2,3-diphenylbutane, dicumyl peroxide, dibenzoyl peroxide, diisopropyl peroxydicarbonate, tert-butyl monoperoxymaleate, 2,5-dimethyl-2,5-di(tert-butylperoxy)hexane, tert-butylperoxy 2-ethylhexyl carbonate, tert-amyl peroxy-2-ethylhexanoate, tert-amyl peroxypivalate, tert-amylperoxy 2-ethylhexyl carbonate, 2,5-dimethyl-2,5-di(2-ethylhexanoylperoxy) hexane 2,5-dimethyl-2,5-di(tert-butylperoxy)hexpe-3, di(3-methoxybutyl)peroxydicarbonate, diisobutyryl peroxide, tert-butyl peroxy-2-ethylhexanoate (trigonox 21 S), 1,1-di(tert-butylperoxy)cyclohexane, tert-butyl peroxyneodecanoate, tert-butyl peroxy-pivalate, tert-butyl peroxyneoheptanoate, tert-butyl peroxydiethylacetate, 1,1-di(tert-butylperoxy)-3,3,5-trimethylcyclohexane, 3,6,9-triethyl-3,6,9-trimethyl-1,4,7-triperoxonane, di(3,5,5-trimethylhexanoyl) peroxide, tert-butyl peroxy-3,5,5-trimethyl hexanoate, 1,1,3,3-tetramethylbutyl peroxy-2-ethylhexanoate, 1,1,3,3-tetramethyl-butyl peroxyneodecanoate, tert-butyl peroxy-3,5,5-trimethyl hexanoate, cumyl per-oxyneodecanoate, di-tert-butyl peroxide, tert-butylperoxy isopropyl carbonate, tert-butyl peroxybenzoate, di(2-ethylhexyl) peroxydicarbonate, tert-butyl peroxyacetate, isopropylcumyl hydroperoxide, tert-Butyl cumyl peroxide, and mixture thereof.

Normally the thermal free radical initiator with higher decomposition rate is preferred, as this can generate free radicals more easily at common cure temperature (80-130° C.) and give faster cure speed, which can reduce the contact time between cur-able composition and LC, and reduce the LC contamination. On the other hand, if the decomposition rate of initiator is too high, the viscosity stability at room temperature will be influenced and thereby reducing the work life of the sealant.

To balance the reactivity and viscosity stability of the composition, the thermally curing agent is 0.1% to 50%, preferably from 1% to 40%, by weight of the thermally curable resin composition.

Additional Components

The thermally curable resin composition may further comprise additional components to improve or modify properties such as flowability, dispensing or printing property, storage property, curing property and physical or mechanical property after being curing.

The additive that may be contained in the composition as needed includes but not limited to organic or inorganic filler, thixotropic agent, silane coupling agent, diluent, modifier, coloring agent such as pigment and dye, surfactant, preservative, stabilizer, plasticizer, lubricant, defoamer, leveling agent and the like. In one embodiment, the composition preferably comprises an additive selected from the group consisting of inorganic or organic filler, thixotropic agent, silane coupling agent, and mixture or combination thereof.

The filler may include, but not limited to, inorganic filler such as silica, diatomaceous earth, alumina, zinc oxide, iron oxide, magnesium oxide, tin oxide, titanium oxide, magnesium hydroxide, aluminium hydroxide, magnesium carbonate, barium sulphate, gypsum, calcium silicate, talc, glass bead, sericite activated white earth, bentonite, aluminum nitride, silicon nitride, and the like; meanwhile, organic filler such as poly(methyl methacrylate), poly(ethyl methacrylate), poly(propyl methacrylate), poly(butyl methacrylate), butylacrylate-methacrylic acid-methyl methacrylate copolymer, poly(acrylonitrile), polystyrene, polybutadiene, polypentadiene, polyisoprene, polyisopropylene, and the like. These can be used alone or in combination thereof.

The thixotropic agent includes, but not limited to, talc, fume silica, superfine surface-treated calcium carbonate, fine particle alumina, plate-like alumina; layered compound such as montmorillonite, spicular compound such as aluminium borate whisker, and the like. Among them, talc, fume silica and fine alumina are preferred.

The silane coupling agent includes, but not limited to, γ-aminopropyltriethoxysilane, γ-mercaptopropyltrimethoxysilane, γ-methacryloxypropyltrimethoxysilane, γ-glycidoxypropyltrimethoxylsilane, and the like. Commercially available examples are SH6062, SZ6030 (produced by Toray-Dow Corning Silicone Inc.), KBE903 and KBM803 (produced by Shin-Etsu Silicon Inc.).

The thermally curable resin composition has a viscosity of 10 to 1000 Pa·s, preferably from 50 to 500 Pa·s at 25° C. at 1.5 s⁻¹ shear rate as measured by a TA Instrument AR2000ex Rheometer (TA Instruments).

Step 2)

In step 2), the thermally curable resin composition applied on the first substrate was heated or exposed to infrared light in the first thermal curing so as to temporarily cure the composition and obtain a partially cured product.

The duration of the first thermal curing may vary from 0.5 min to 60 min, preferably from 1 min to 40 min. The curing temperature of the first thermal curing in the step 2) is from 40° C. to 75° C., more preferably from 40° C. to 70° C. If the curing temperature in the step 2) is higher than 75° C., the adhesion of the partially cured product to the substrate will be deteriorated, which in turn may have negative influence on the alignment of the cell assembly and the resistance to liquid crystal penetration and leakage after the secondary thermal curing in step 5). If the curing temperature in the step 2) is lower than 40° C., the duration of the thermal curing may be increased, and thus is not cost-efficient in a large-scale and automated manufacturing process. The partially cured product may have a viscosity of 400 to 30000 Pa·s, preferably 1000 to 20000 Pa·s at 25° C. at 1.5 s⁻¹ shear rate as measured by a TA Instrument AR2000ex Rheometer (TA Instruments). If the viscosity is too high, the partially cured product may not be compressed to achieve an excellent bonding and sealing of the two substrate. If the viscosity is too low, the assembly temporarily sealed may not be firm enough, and thus may cause misalignment and even the penetration and leakage of the liquid crystal.

Step 3)

In step 3), the liquid crystal is then dropped onto the center area encircled by the sealing region in the frame shape on the surface of the first substrate or the corresponding area on the second substrate. “Corresponding area” means the area of the second substrate corresponding to the center area surrounded by the sealing region of the first substrate when the substrates were attached. Preferably, the liquid crystal is then dropped onto the center area encircled by the sealing region on the first substrate.

Due to the improved process sequence of the present invention, the thermally curable resin composition is thermally cured to obtain a partially cured product in the first thermal curing step before the attachment of the two substrates. It is practical for the inventive process to easily overcome the shadow cure issue which commonly appears in conventional ODF process.

Step 4)

In step 4), a second substrate was superposed or overlaid on the first substrate so that the two substrates can be temporarily fixed by the partially cured product there between.

The second substrate used in the present invention may be comprised of materials same as or different to that of the first substrate, and preferably comprised of materials same as that of the first substrate. In one preferred embodiment, both of the first and second substrates are made of transparent glass.

Step 5)

In step 5), the second thermal curing by such as heating or infrared radiation is applied to the partially cured resin product so as to achieve the final curing strength of the sealant, whereby the two substrates are finally fixed. The second thermal curing in the step 5) is generally heated at a curing temperature of from 80° C. to 150° C., preferably from 90° C. to 130° C., with the duration of from 1 hour to 2 hours, preferably from 30 min to 90 min.

By the aforementioned process, the major part of the LCD panel is manufactured.

In another aspect, the present invention also concerns the thermally curable resin composition used for said process of producing a liquid crystal display according to the present invention.

In yet another aspect, the present invention concerns liquid crystal display manufactured by said process of producing a liquid crystal display according to the present invention.

The producing process and the thermally curable resin composition used in the present invention may be also used for other applications than the liquid crystal one-drop-filling process, where precise assembling without displacement is necessary.

Not bound by any theory, the ODF producing process comprising two steps of thermal curing in which the first thermal curing is arranged prior to the attachment of substrates is suitable for various types of thermally curable sealant compositions, and allows for an improved performance of LCD cell assembly, such as targeted narrow sealant width less than 0.5 mm, accurate alignment, excellent resistance to liquid crystal penetration and leakage, thereby overcoming the long felt and unmet need in prior art.

### EXAMPLES

The following examples are intended to assist one skilled in the art to better understand and practice the present invention. The scope of the invention is not limited by the examples but is defined in the appended claims. All parts and percentages are based on weight unless otherwise stated.

ODF Process

(1) Inventive Process

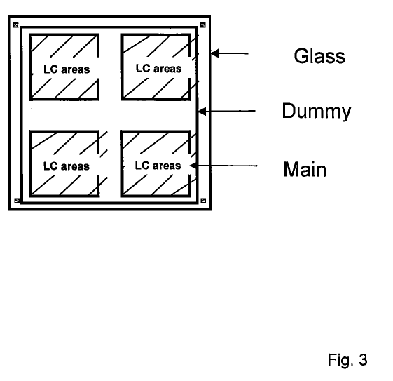

The materials of thermally curable resin composition listed in Table 1 were sufficiently mixed by a stirrer and then a three roll miller to give a well distributed sealant composition. Then 1 part by weight of 3.5 μm spacer was added to 100 parts by weight of the sealant composition. As shown in FIG. 3, the degassed sealant composition was dispensed by using a MLC6200 dispenser (manufactured by Musashi) in a rectangular shape at periphery of the surface of a glass substrate (50 mm×50 mm). Another rectangular shape surrounding this rectangular shape was dispensed as the closed dummy seal. The diameter of dispensing nozzle is 0.2 mm, and the dispensing speed is 70 mm/s.

The substrate dispensed with the sealant composition was placed into an oven for the first thermal curing according to the temperature and duration as listed in Table 2, and then was taken out. Later some grams liquid crystal (105% liquid crystal quantity calculated in term of the sealing volume) was dropped onto the central area of the substrate encircled by the sealing region and degassed in vacuum, followed by overlaying a second glass substrate on the first substrate at 3 KPa. After the attachment of two glass substrates, the vacuum was released to obtain the LCD cell assembly. Afterwards, the cell assembly was thermally treated in an oven at 120° C. for 60 minutes for the second thermal curing to complete a mimic LCD cell with the one-drop-filling process.

(2) Comparative Process

The comparative process is the same as the inventive process except that the first thermal curing in step 2) was not conducted.

TABLE 1
Formulation of thermally curable resin/sealant compositions
(The units of values are represented by weight percentage)

| | | Sealant composition | | |
|---|---|---|---|---|
| Component | Trade name | 1 | 2 | 3 |
| Thermally curable resin | Genomer 2281¹ | 41.6 | — | 37.0 |
| | Urethane acrylate | 41.6 | — | — |
| | 00-022² | | | |
| | YL980³ | — | 66.7 | 37.0 |
| Thermally curing agent | EH-4357S⁴ | 16.8 | 33.3 | 26.0 |

¹Genomer 2281, a modified bisphenol A type epoxy diacrylate, manufactured by RAHN Inc.
²Urethane acrylate 00-022, a hydroxy functional aliphatic urethane acrylate, manufactured by RAHN Inc.
³JER YL 980, a bisphenol A type epoxy resin, manufactured by Mitsubishi Chemical Corporation.
⁴EH-4357S, a modified amine, manufactured by ADEKA Corporation, further grounded to fine powder before using.

Testing Method

(1) Viscosity

The initial viscosity of thermally curable resin compositions 1 to 3 was measured by a TA Instrument AR2000ex Rheometer (TA Instruments) at 25° C. at 1.5 s⁻¹ shear rate and results are shown in Table 2. As used herein, the initial viscosity means the viscosity of the thermally curable resin composition to be applied in step 1). After the initial viscosity testing was finished, the rheometer was continued to be kept in a heating stage to the curing temperature and duration as listed in Table 2, and then turned to 25° C. to test the viscosity of the partially cured product by a TA Instrument AR2000ex Rheometer (TA Instruments) at 1.5 s⁻¹ shear rate, and the results are also shown in Table 2.

(2) The Evaluation of the Cell Assembly with the First Thermal Curing

After attaching the substrates, the LCD cell assembly was then observed under a microscope at magnification of ×100. If the line width of the sealant was much less than the theoretically calculated value in terms of the section area, meanwhile the liquid crystal could not touch the sealant, the performance of the cell assembly was recorded as “poor”. If the line width was very close or same to the theoretically calculated value in terms of the section area, and also the liquid crystal could touch the sealant, the performance was recorded as “good”. If the partially cured sealant could barely wet the opposite substrate, but still could seal the liquid crystal, the performance was recorded as “generic”. The evaluation results of the cell assembly are showed in Table 2.

(3) The Evaluation of the Cell Assembly with the Second Thermal Curing

The obtained mimic LCD cell was inspected under a microscope at magnification of ×100 to verify the sealing performance, including the sealing shape maintenance and liquid crystal penetration and leakage. The final sealing performance was recorded as “good” if the sealing shape was well kept with no liquid crystal penetration, and no gap issue exist. The performance was recorded as “generic” if the sealing shape could be kept but had 20% to 50% penetration, or exhibited slight gap issue. It was recorded as “poor” if there was higher than 50% penetration or liquid crystal leakage, or the sealant could not seal the liquid crystal. The results of the final LCD panel sealing performance are shown in Table 2.

TABLE 2
Results of testing and evaluation

| | Sealant composition 1 | | | Sealant composition 2 | | | Sealant composition 3 | | | |
|---|---|---|---|---|---|---|---|---|---|---|
| | Ex. 1 | Ex. 2 | CE. 1 | Ex. 3 | Ex. 4 | CE. 2 | Ex. 5 | Ex. 6 | Ex. 7 | CE. 3 |
| Initial viscosity, Pa · s | 232 | 232 | 232 | 190 | 190 | 190 | 450 | 450 | 450 | 450 |
| Temperature of first | 60 | 70 | 80 | 60 | 70 | 80 | 50 | 60 | 70 | 80 |
| thermal curing, ° C. | | | | | | | | | | |
| Duration of first | 10 | 5 | 3 | 5 | 2 | 1 | 20 | 5 | 5 | 1 |
| thermal curing, min | | | | | | | | | | |
| Viscosity of partially | 1800 | 5000 | 14400 | 785 | 7800 | >10⁷ | 1920 | 3000 | 8000 | >10⁷ |
| cured product, Pa · s | | | | | | | | | | |
| Performance of cell | Good | Good | Generic | Good | Good | Poor | Good | Good | Good | Poor |
| assembly after first | | | | | | | | | | |
| thermal curing | | | | | | | | | | |
| Performance of cell | Good | Good | Generic | Good | Good | Poor | Good | Good | Good | Poor |
| assembly after second | | | | | | | | | | |
| thermal curing | | | | | | | | | | |

As can been seen in Table 2, the inventive examples Ex. 1 to Ex. 7 produced by the ODF process according to the present invention exhibited an excellent performance of LCD cell assembly both after the temporary thermal curing and the final thermal curing. However, the comparative examples CE 1 to CE 3 showed “generic” or “poor” performance of LCD cell assembly. It is mainly due to the higher curing temperature in the first thermal curing step, which was commonly applied in the prior art. Under such higher temperature range, the viscosity of the partially cured sealant product was dramatically increased, and in turn resulting in an unsatisfactory sealing when the two substrates were attached by force. Therefore, the quality of the produced LCD panels was deteriorated.

In addition, all assembly performance of examples produced by the comparative process with same sealant compositions were “poor”, which demonstrated that the inventive process including a two-step thermal curing improved the property of the LCD cell assembly, especially with the new trends and challenges in the art.

1. A process of producing a liquid crystal display having a liquid crystal layer between a first substrate and a second substrate, comprising steps of:
1) applying a thermally curable resin composition on a sealing region at a periphery of a surface of the first substrate;
2) conducting a first thermal curing of the thermally curable resin composition at a temperature of 40° C. to 75° C., and obtaining a partially cured product;
3) dropping liquid crystal on a central area encircled by the sealing region of the surface of the first substrate or the corresponding area of the second substrate, and forming the liquid crystal layer;
4) overlaying the second substrate on the first substrate; and
5) conducting a second thermal curing of the partially cured product.

2. The process of producing a liquid crystal display according to claim 1, wherein the thermally curable resin composition comprises a thermally curable resin and a thermally curing agent.

3. The process of producing a liquid crystal display according to claim 2, wherein the thermally curable resin is selected from the group consisting of a (meth)acrylic resin, an epoxy resin, and combination thereof.

4. The process of producing a liquid crystal display according to claim 2, wherein the thermally curable resin is present from 30% to 95% by weight of the thermally curable resin composition.

5. The process of producing a liquid crystal display according to claim 2, wherein the thermally curing agent is present from 0.1% to 50% by weight of the thermally curable resin composition.

6. The process of producing a liquid crystal display according to claim 1, wherein the thermally curable resin composition has a viscosity of 10 to 1000 Pa·s at 25° C. at 1.5 s⁻¹ shear rate.

7. The process of producing a liquid crystal display according to claim 1, wherein the duration of the first thermal curing is from 0.5 min to 60 min.

8. The process of producing a liquid crystal display according to claim 1, wherein the curing temperature of the first thermal curing is from 40° C. to 70° C.

9. The process of producing a liquid crystal display according to claim 1, wherein the partially cured product has a viscosity of 400 to 30000 Pa·s at 25° C. at 1.5 s⁻¹ shear rate.

10. The process of producing a liquid crystal display according to claim 1, wherein the curing temperature of the second thermal curing is from 80° C. to 150° C.

11. The process of producing a liquid crystal display according to claim 1, wherein the duration of the second thermal curing is from 1 hour to 2 hours.

12. A thermally curable resin composition used for the process of producing a liquid crystal display according to claim 1.

13. A liquid crystal display manufactured by the process of producing a liquid crystal display according to claim 1.
